(19) United States
(12) Patent Application Publication
(10) Pub. No.: US 2026/0196085 A1
(43) Pub. Date: Jul. 9, 2026

(54) SYSTEM FOR ACOUSTIC DIAGNOSTICS OF VEHICLES

(71) Applicant: V2M Inc., Boca Raton, FL (US)

(72) Inventors: Petr BAKULOV, Boca Raton, FL (US); Igor KORDUNSKY, Quincy, MA (US); Sergey SURGUCHEV, Boca Raton, FL (US); Vladislav ZAIGRAEV, Boca Raton, FL (US); Andrew MALTZEV, Boca Raton, FL (US); Alexsandr IOVLEV, Boca Raton, FL (US)

(21) Appl. No.: 19/554,946

(22) Filed: Mar. 3, 2026

Related U.S. Application Data
(63) Continuation-in-part of application No. 18/122,391, filed on Mar. 16, 2023.
(60) Provisional application No. 63/321,164, filed on Mar. 18, 2022.
(60) Provisional application No. 63/766,119, filed on Mar. 3, 2025.

(51) Int. Cl. G07C 5/08; G06N 3/0442; G06N 3/0464; G07C 5/00; H04R 1/08; H04R 1/42

(52) U.S. Cl. CPC G07C 5/0808; G06N 3/0442; G06N 3/0464; G07C 5/008; G07C 5/0825; G07C 5/0833; H04R 1/08; H04R 1/42; H04R 2499/13

(57) ABSTRACT

A multi-function acoustic diagnostic system for vehicles is disclosed. The system comprises at least one acoustic data acquisition block including one or more microphones, a control unit, and communication interfaces. The system captures acoustic signals during vehicle operation and analyzes the signals using artificial intelligence models, including deep neural networks and autoencoder architectures. The system detects anomalies based on reconstruction error, classifies malfunction signatures, and generates diagnostic reports. In certain embodiments, the system is portable and transferable between vehicles. In other embodiments, the system is permanently installed and integrated into a vehicle network. A predictive analysis module may forecast future failures using historical acoustic data and time-series models. The invention provides real-time and predictive vehicle health assessment.

### TECHNICAL FIELD OF THE INVENTION

The present invention relates generally to vehicle diagnostics and monitoring systems. More specifically, the present disclosure relates to a system for acoustic diagnostics of a vehicle, which is configured to capture and analyze acoustic signals from moving components of the vehicle for vehicle health diagnostics.

### BACKGROUND OF THE INVENTION

Modern vehicles are equipped with advanced control, monitoring, and diagnostic technologies primarily focused on optimizing engine and transmission performance. However, critical components, such as wheel hub bearings, shafts, axles, ball joints, steering parts, belts, and pulleys, often lack dedicated diagnostic attention. Malfunctions in these areas are frequently overlooked, potentially leading to severe component failures and safety hazards. Extrapolated data from automotive dealerships indicate that approximately 27% of vehicle maintenance requests stem from diagnostic inquiries, with over half arising from reports of atypical noises.

Various solutions have been developed to address abnormal vehicle noises and assist in malfunction diagnostics. Conventional acoustic diagnostic methods typically require specialized equipment available only at service centers or laboratories, limiting their application to engine diagnostics and excluding other vehicle components. Additionally, mobile applications designed to detect vehicle malfunctions often necessitate the user device to be held close to the sound source, rendering them ineffective for diagnosing issues while the vehicle is in motion or for components not easily accessible. Some systems involve transmitting substantial data volumes via wireless channels, which may not always be available or reliable.

Recognizing these limitations, there is a clear need for an additional acoustic diagnostic tool to assist drivers and mechanics in identifying malfunctions before critical component failures occur.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a system for acoustic diagnostics of a vehicle, which may be mounted (removably or rigidly) on the vehicle to perform advanced, artificial intelligence (AI)-based analysis of sounds produced by moving (e.g., rotating) vehicle components in order to detect their abnormal conditions (caused by existing mechanical issues).

The objective above is achieved by the features of the independent claim in the appended claims. Further embodiments and examples are apparent from the dependent claims, the detailed description, and the accompanying drawings.

According to an aspect of the present disclosure, the system comprises at least one acoustic data acquisition block mounted on the vehicle, a communication interface, and a processing unit mounted on the vehicle and coupled to each of the at least one acoustic data acquisition block via the communication interface. Each of the at least one acoustic data acquisition block is configured to capture acoustic signals from the moving components of the vehicle, and the processing unit is configured to analyze the acoustic signals to detect the abnormal condition of each of the moving components of the vehicle. Each of the at least one data acquisition block comprises at least two microphones, a memory, and optionally a control unit. The microphones are oriented in opposite directions and configured to capture the acoustic signals from the moving components of the vehicle, and the control unit configured to convert the acoustic signals into digital data, store the digital data in the memory, and transmit the digital data to the processing unit via the communication interface. The processing unit is configured to analyze the digital data by using an AI model that is configured (i.e., pre-trained) to receive the digital data as input data, compare the digital data to a normal (i.e., anomaly-free) sound pattern of each of the moving components of the vehicle, and generate, based on the results of said comparison, a diagnostic output indicating whether at least one of the moving components of the vehicle is in the abnormal condition. The above description is just one of possible embodiments; as an example, the data acquisition block and processing unit might be combined into one enclosure.

In the system so configured, the acoustic data acquisition block(s) and the processing unit may be portable, allowing their quick mounting on and removal from the vehicle; alternatively, the acoustic data acquisition block(s) and the processing unit may be permanently installed on the vehicle. In the former case, the system may be intended for quick and temporary installation on a variety of vehicles, enabling rapid and efficient diagnostic testing across multiple vehicles. The permanently installed system (i.e., when the acoustic data acquisition block(s) and the processing unit are rigidly mounted on the vehicle) may be tailored to a particular vehicle, continuously learning normal and abnormal sounds and warning an operator about possible issues.

It should be also noted that the system so configured is particularly useful for diagnosing the health of rotating and moving components of the vehicle, such as engine and power transmission parts, suspension and steering components, brake system actuators, and engine attachments like a generator, a starter, and an air conditioning compressor, etc.

In one exemplary embodiment, the system comprises at least one first acoustic data acquisition block mounted on a front part of the vehicle, a second acoustic data acquisition block mounted on a rear part of the vehicle, and a third acoustic data acquisition block mounted on a middle part of the vehicle. By using multiple acoustic data acquisition blocks strategically placed on different parts of the vehicle, it is possible to capture acoustic signals from various components, such as the front, rear, or engine compartment of the vehicle, which may make the acoustic diagnostics of the entire vehicle more efficient.

In one exemplary embodiment, each of the at least one acoustic data acquisition block further comprises at least two acoustic ducts each arranged to concentrate and redirect the acoustic signals from the moving components of the vehicle towards one or more microphones. By using the acoustic ducts (also referred to as sound guides), one may enhance signal capture efficiency, which in turn may provide improved diagnostic accuracy.

In one exemplary embodiment, each of the at least one acoustic data acquisition block further comprises an autonomous power source configured to power the control unit. The autonomous power source may be further configured to recharge from a power source of the vehicle (e.g., vehicle battery, control electronics, onboard modules, auxiliary batteries, etc.). In this case, the acoustic data acquisition block(s) may operate independently of the vehicle's main electrical system, meaning that the acoustic data acquisition block(s) may operate even when the vehicle is turned off, allowing for continuous monitoring or data logging without relying on the vehicle battery. Furthermore, such independently functioning acoustic data acquisition block(s) may be less susceptible to electronical noise, since it(they) is(are) electrically isolated from the vehicle's main electrical system—this may improve signal quality and reliability.

In one exemplary embodiment, the communication interface comprises one of a wireless interface, a wired interface and an optical interface. These interfaces enable flexible installation and use of the system across different vehicle architectures.

In one exemplary embodiment, the system further comprises an intermediate user device (e.g., smartphone, laptop, tablet computer, etc.), and each acoustic data acquisition block is wirelessly coupled to the intermediate user device. In this embodiment, the control unit of each acoustic data acquisition block is further configured to transmit the digital data to the intermediate user device, and the intermediate user device is configured to forward the digital data to the processing unit if the processing unit fails to receive the digital data via the communication interface. The intermediate user device may facilitate the connection between the acoustic data acquisition block(s) and the processing unit if the communication interface is unavailable or functions improperly (e.g., abruption of wire, loss of connection, out of cellular coverage area, etc.). The intermediate user device may also perform at least part if not all of the functions of the processing unit if it has sufficient computational capacity (e.g., the intermediate user device may perform suitable data preprocessing with respect to the digital data, such as temporarily store collected data, noise reduction or filtering, extraction of time- and frequency-domain features, dimensionality reduction, etc.). With enough computational capacity the intermediate device essentially becomes a processing unit.

In one exemplary embodiment, the intermediate user device comprises a positioning module configured to provide metadata to each of the at least one acoustic data acquisition block. The metadata comprises positioning, velocity, and acceleration information about the vehicle and environmental data. In this embodiment, the control unit of each acoustic data acquisition block is further configured to store the metadata in the memory and transmit the metadata together with the digital data to the processing unit. This metadata may be used by the AI model to improve the accuracy of the diagnostic output and, optionally, predictions of future abnormal conditions of the moving components of the vehicle and maintenance needs with respect to them.

In one exemplary embodiment, the processing unit is further configured to transmit the diagnostic output to the intermediate user device. In this case, the intermediate user device may serve as both a storage means and a display interface for the diagnostic output.

In one exemplary embodiment, the AI model comprises a deep neural network (DNN) having an autoencoder architecture that integrates convolutional neural networks (CNNs) and attention mechanisms. This type of the AI model may provide better diagnostic accuracy.

In one exemplary embodiment, the processing unit is further configured, if the diagnostic output indicates the abnormal condition of at least one of the moving components of the vehicle, to provide at least one of a visual warning and an audio warning to a user of the vehicle.

In one exemplary embodiment, the diagnostic output further indicates, in case of the abnormal condition of at least one of the moving components of the vehicle, at least one of: (i) a severity level associated with the abnormal condition of said at least one of the moving components of the vehicle; (ii) a malfunction class associated with the abnormal condition of said at least one of the moving components of the vehicle; (iii) estimated repair cost; and (iv) a maintenance scheduling recommendation. This additional information may help a vehicle user (driver or mechanic) make a proper decision on how to proceed further with the moving component(s) producing abnormal sounds.

In one exemplary embodiment, the system further comprises a remote AI server (e.g., cloud-based server) storing the AI model. In this embodiment, the processing unit is further configured to transmit the digital data and the diagnostic output to the remote AI server, and the remote AI server is configured to obtain updates to the AI model by training the AI model based on the digital data and the diagnostic output and to transmit the updates to the processing unit. With the aid of this server, it is possible to provide reduced local computation and consistent performance across multiple processing units installed on a variety of vehicles (i.e., the server may cause all the processing units to use the same updates to the AI model).

In one exemplary embodiment, the AI model is further configured to predict future abnormal conditions of the moving components of vehicle and maintenance needs with respect to the moving components of the vehicle based on historical vehicle diagnostics data. The historical diagnostics data comprises at least one of: (i) previous diagnostic outputs generated by the AI model; (ii) malfunction classes corresponding to abnormal conditions indicated in the previous diagnostic outputs; (iii) an average speed of travel; (iv) a time of year; (v) time- and frequency-domain features of the acoustic signals (e.g., mean, variance, frequency components); (vi) a mileage of the vehicle; (vii) driving conditions (e.g., urban or highway driving, and/or weather conditions such as temperature, humidity, rain, snow, etc.); and (viii) a maintenance history of the vehicle (e.g., previous repairs, part replacements). This information may allow the vehicle user to make proactive decisions about repairing or replacing the vehicle moving components that are potentially faulty in the future.

In one exemplary embodiment, the AI model is configured to predict the future abnormal conditions and the maintenance needs by using a time series model to analyze trends and patterns in the acoustic signals over time. The time series model may include, but is not limited to, an auto regressive integrated moving average (ARIMA) model, a long short-term memory (LSTM) model, and/or a transformer-based time series model. The time series model may make such predictions more efficiently (in terms of accuracy and reliability).

Other features and advantages of the present disclosure will be apparent upon reading the following detailed description and reviewing the accompanying drawings

### BRIEF DESCRIPTION OF DRAWINGS

The present disclosure is explained below with reference to the accompanying drawings in which:

FIGS. 1A and 1B shows a block diagram of a removably mounted acoustic data acquisition block that may be used in a system for acoustic diagnostics of a vehicle in accordance with one exemplary embodiment;

FIGS. 2A and 2B show two isometric views (in the form of a schematic drawing and a photograph, respectively) of the hardware implementation of the removably mounted acoustic data acquisition block with an autonomous power supply (i.e., a (rechargeable) battery);

FIG. 3 shows one exemplary arrangement of two acoustic data acquisition blocks under the front and rear parts of the vehicle, as well as an optional intermediate user device wirelessly coupled to the two acoustic data acquisition blocks;

FIG. 4 shows another exemplary arrangement of two acoustic data acquisition blocks inside the front and rear parts of the vehicle, as well as the optional intermediate user device wirelessly coupled to the two acoustic data acquisition blocks;

FIG. 5 shows an exemplary configuration of the system, in which the optional intermediate user device is wirelessly coupled to the acoustic data acquisition blocks and a remote (cloud-based) server;

FIG. 6 shows a block diagram of a rigidly mounted acoustic data acquisition block that may be used in the system in accordance with one exemplary embodiment;

FIG. 7 shows an exemplary arrangement of the rigidly mounted acoustic data acquisition block in the vehicle;

FIG. 8 shows a block diagram of the system with four rigidly mounted acoustic data acquisition blocks, a processing unit, and connection cables in accordance with one exemplary embodiment;

FIGS. 9A and 9B show one exemplary configuration of the system with two rigidly mounted acoustic data acquisition blocks and the processing unit on a truck; and

FIG. 10 shows one exemplary configuration of the system with three rigidly mounted acoustic data acquisition blocks and the processing unit on a passenger car.

### DETAILED DESCRIPTION

Various embodiments of the present disclosure are further described in more detail with reference to the accompanying drawings. However, the present disclosure can be embodied in many other forms and should not be construed as limited to any certain design or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the system disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “exemplary embodiment” should not be construed as preferable or having an advantage over other embodiments.

The exemplary embodiments disclosed herein relate to a multi-function system for acoustic diagnostics of vehicles, which is designed to capture and analyze acoustic signals for vehicle health diagnostics. The system comprises at least one acoustic data acquisition block, which is rigidly or removably mounted on a vehicle and preferably enclosed within a waterproof housing. Each acoustic data acquisition block includes at least two microphones, a memory and a control unit. The control unit may be implemented as a microcontroller or computer that could process (i.e., perform analog-to-digital conversion (ADC)) and store the captured acoustic signals in the form of digital data in the memory. The control unit within acoustic data acquisition block can be powered either autonomously or via power drawn from the vehicle. The system further comprises a (e.g., wireless or wired) communication interface via which the control unit of each acoustic data acquisition block can communicate with a processing unit which could be also installed on the vehicle or a remote processing unit. The processing unit utilizes an AI-based algorithm or model to process and analyze the digital data, allowing for the identification of vehicle component defects based on distinct acoustic signatures. The results of this analysis are returned to the vehicle operator and, in some embodiments, to the vehicle manufacturer, offering real-time or near real-time diagnostic feedback.

The acoustic data acquisition block may also detect whether the vehicle is in motion or idle and may capture the acoustic signals based on the vehicle's operational status or upon a user's command. The captured acoustic signals may be periodically transmitted to the processing unit for further analysis, which may be PC-based or cloud-based. In some embodiments, the system may include an intermediate user device that facilitates the connection between the acoustic data acquisition block(s) and the processing unit, providing metadata related to the vehicle's location and environmental data. This intermediate user device may perform at least part of the functions of the processing unit if it has sufficient computational capacity.

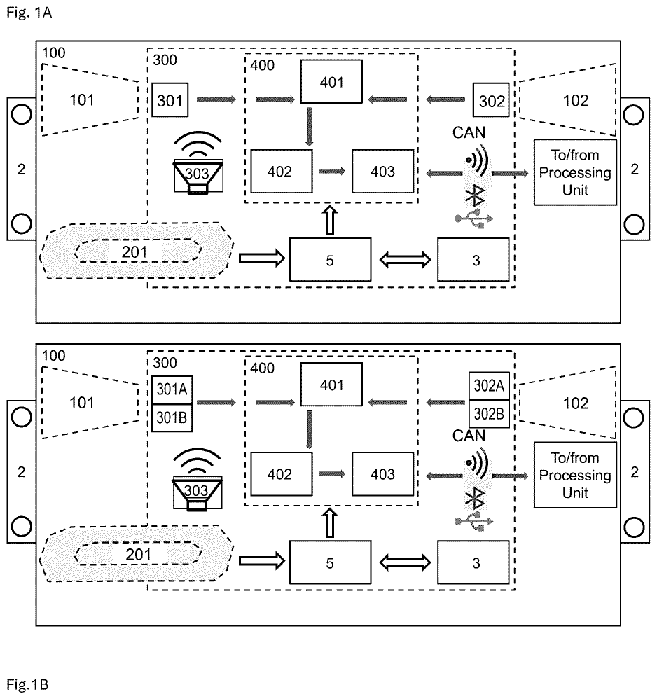

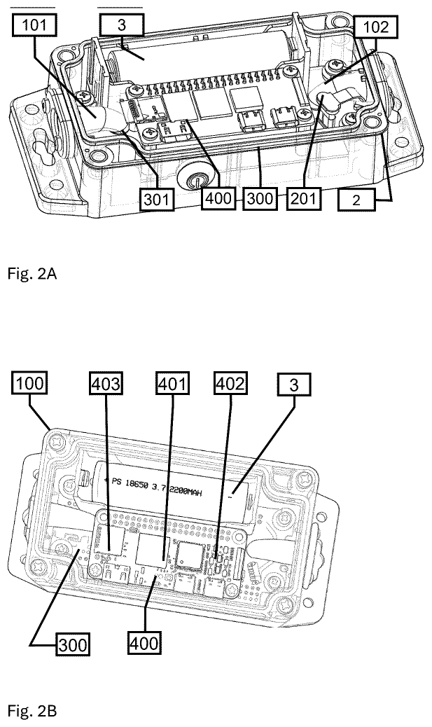

FIGS. 1A and 1B shows a block diagram of a removably mounted (i.e., portable and transferable) acoustic data acquisition block that may be used in the proposed system for acoustic diagnostics of a vehicle (truck, car, etc.) in accordance with one exemplary embodiment. The block is housed within a waterproof enclosure 100, which includes mounting brackets 2 for secure and quick installation and removal from the vehicle. The system employs (optional) acoustic ducts (or sound guides) 101 and 102, which are oriented in opposite directions to capture a broad range of acoustic signals and redirect them towards the acoustic sensors 301 and 302. Each of these sensors 301 and 302 could be a digital MEMS or an analog microphone mounted on a carrier printed circuit board 300. These sound guides allow microphones to capture sounds from opposite directions; however, microphones themselves can be oriented in opposite directions. These sensors collect acoustic signals produced by the vehicle's moving parts, such as wheel hubs, axles, bearings, steering, and suspension components. Capturing sounds from opposite directions enables the detection of issues with specific components, such as distinguishing between the left or right wheel hub.

To increase system reliability, the acoustic data acquisition block include two separate sensors (microphones) 301A,301B and 302A, 302B, for each side of directional sound recognition, and a speaker 303 to create test sounds. Two microphones on each side might have different sensitivity and bandwidth to better cover sound levels of the real test conditions. This allows calibration of the units and enables the detection of issues with specific components of the system, such as contaminated sound entries 101, 102 or failing microphones 301, 302.

The acoustic data acquisition block shown in FIG. 1 is powered by a rechargeable battery 3, managed by a power management unit 5, and can be wirelessly recharged through a charging receiver unit 201 or via USB. The acoustic data acquisition block also includes a single board computer 400 that houses a control unit 401 configured to store data in a memory 402 and communicate with external devices through a communication unit or interface 403. The interface 403 supports, for example, Ethernet, USB, controller area network (CAN), Wi-Fi and Bluetooth connectivity. It should be noted that the interface 403 may use any other communication protocols or methods, such as communication using light.

In FIG. 1, the solid arrows designate data communication lines, while the empty arrows designate power lines.

It should be noted that each of the control unit 401 and the processing unit can be implemented as a CPU, general-purpose processor, single-purpose processor, microcontroller, microprocessor, application specific integrated circuit (ASIC), field programmable gate array (FPGA), digital signal processor (DSP), complex programmable logic device, graphics processing unit (GPU), tensor processing unit (TPU), etc. In some embodiments, the control unit 401 and/or the processing unit may be implemented as any combination of one or more of the aforesaid. As an example, the control unit 401 and/or the processing unit may be a combination of two or more microprocessors

As for the memory 402, it may store processor-executable instructions which, when executed by the control unit 401, cause the control unit 401 to perform the processing of the acoustic signals (e.g., ADC) and store the processed acoustic signals (e.g., in the form of digital data) in the memory 402. Preferably, the memory 402 is implemented as a classical nonvolatile memory used in the modern electronic computing machines, such as read-only memory (ROM), ferroelectric random-access memory (RAM), programmable ROM (PROM), electrically erasable PROM (EEPROM), solid state drive (SSD), flash memory, etc.

FIGS. 2A and 2B show two isometric views of the hardware implementation of the removably mounted acoustic data acquisition block with an autonomous power supply (i.e., the rechargeable battery 3). More specifically, FIG. 2A shows the isometric view in the form of a schematic drawing of the 3D model of the acoustic data acquisition block, while FIG. 2B shows the isometric view in the form of a photograph of the manufactured (based on the schematic drawing) acoustic data acquisition block.

FIG. 3 shows one exemplary arrangement of two acoustic data acquisition blocks 100A and 100B under the front and rear parts of the vehicle, as well as an optional intermediate user device 500 wirelessly coupled to the two acoustic data acquisition blocks. Each of the acoustic data acquisition blocks 100A and 100B is assumed to be implemented as shown in FIGS. 2A and 2B. The blocks may be placed on the front (see 100A) and rear (see 100B) parts of the vehicle, allowing to capture sound of front and rear suspension and power train. As noted earlier, the blocks 100A and 100B are provided with the mounting brackets 2 for easy attachment and removal. The blocks 100A and 100B have wireless connectivity allowing connection to the Internet and to the other parts of the system, such as the intermediate user device 500 (e.g., laptop, mobile phone, a built-in vehicle computer configured to interact with the vehicle user, etc.). The intermediate user device 500 is typically placed inside a vehicle cabin with the operator.

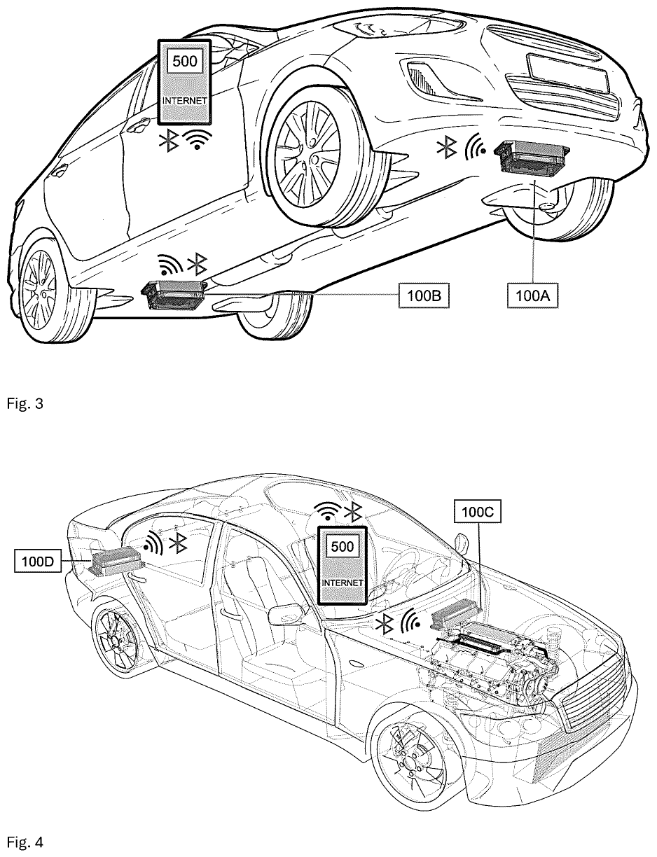

FIG. 4 shows another exemplary arrangement of two acoustic data acquisition blocks 100C and 100D inside the front and rear parts of the vehicle, as well as the optional intermediate user device wirelessly coupled to the two acoustic data acquisition blocks. Again, each of the acoustic data acquisition blocks 100C and 100D is assumed to be implemented as shown in FIGS. 2A and 2B. As an example, the acoustic data acquisition blocks 100C and 100B are placed inside the vehicle, in a motor compartment and trunk, respectively. This placement is useful for electric vehicles capturing sound of an inverter, charger, and battery thermal management. The optional intermediate device 500 is wirelessly connected to each of the blocks 100C and 100D. Instead of the motor compartment, the block 100C may be placed, e.g., in the vehicle cabin.

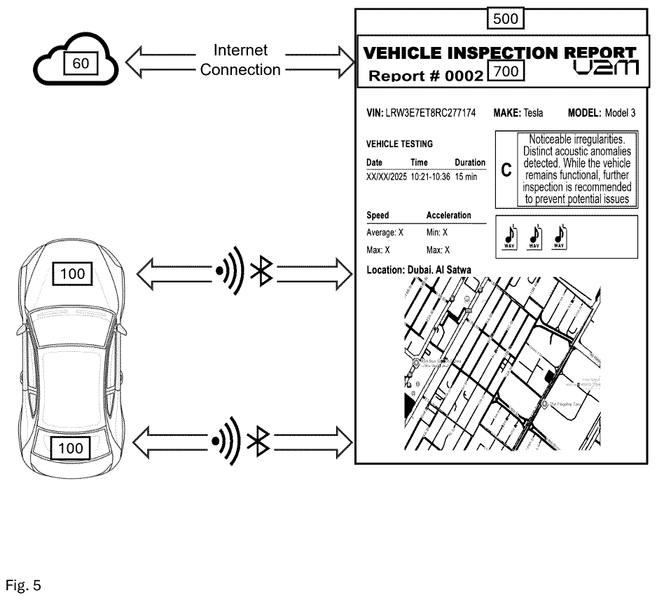

FIG. 5 shows an exemplary configuration of the system, in which the optional intermediate user device 500 is wirelessly coupled to the acoustic data acquisition blocks 100 and a remote (cloud-based) server 600. This device 500 wirelessly connects to the acoustic data acquisition blocks 100 and facilitates two-way communication between the acquisition blocks 100 and the processing unit (not shown). Additionally, the intermediate device can include a positioning module (e.g., GPS unit) to provide real-time location or other positioning information, velocity, and environmental data, such as temperature or weather conditions, which are relevant for the diagnostic analysis. This data could be saved along with the digital data which would help on a further analysis stage. The server 600 is assumed to store a variety of AI models, including the one used by the system, and to properly update the AI model based on the digital data (and other metadata, if required) and provide these updates to the processing unit. In some embodiments, the processing unit may reside in the server 600. What is designated as 700 is a diagnostic output or report that may be also provided to the intermediate user device 500 from the processing unit.

Let us now describe the operational principle of the system with one or more removably mounted acoustic data acquisition blocks.

### AI-Based Anomaly Detection Using DNNs

During operation, one or more acoustic data acquisition blocks 100 capture acoustic data during a test drive. The drive is typically performed on a paved road at variable speeds, for a duration of typically up to 20 minutes, and covering a speed range up to the road's speed limit. As the vehicle operates, the (two or more) microphones 301 and 302 in each acoustic data acquisition block receive acoustic signals, which are converted into electrical signals (e.g., digital data) by the control unit 401. These signals are then preprocessed by the control unit 401 to filter out background noise and irrelevant frequencies, ensuring that only high-fidelity sound data is captured for analysis.

Optionally, the intermediate user device 500 wirelessly transmits different metadata (e.g., vehicle location, velocity, etc.) along with the digital data to the processing unit (which may reside in the cloud-based server 600), where AI-based analysis is performed. The processing unit uses advanced AI techniques, including deep neural networks (DNNs) and autoencoder architectures, to analyze the audio data for anomalies that may indicate potential malfunctions.

The AI algorithms employed in the proposed system with the removably mounted acoustic data acquisition block(s) 100 utilize a DNN model that is specifically designed for anomaly detection. The core of the model is based on an autoencoder architecture, which integrates convolutional neural networks (CNNs) and attention mechanisms to enhance feature extraction and focus on relevant sound patterns during training. The autoencoder is trained exclusively on normal vehicle operational audio data, which allows the system to learn the typical sound patterns produced by the moving components of the vehicle during its normal operation.

In the anomaly detection process, the input acoustic signal captured by the acoustic data acquisition block 100 is passed through the autoencoder model. The autoencoder attempts to reconstruct the input audio signal, and the reconstruction error—i.e., the difference between the input signal and its reconstructed version—is analyzed to detect anomalies. Sounds that exhibit significant deviations from the learned normal patterns are flagged as anomalies, which may indicate malfunctions in the moving components of the vehicle.

To improve the robustness of the model and increase its generalizability to various acoustic environments, audio augmentation techniques are applied during the training phase. These techniques include pitch shifting and time stretching, which modify the frequency and duration of the training data, respectively. This enables the model to better handle different acoustic conditions and vehicle environments during real-world usage.

After the test drive, the recorded audio samples are processed by the system's processing unit, which calculates the reconstruction error for each sample. If the calculated error exceeds a dynamically determined threshold, the sample is classified as anomalous. This threshold is calibrated based on statistical analysis of the training data, ensuring that the system remains accurate across different vehicle types and operating conditions.

The AI model then generates a diagnostic output indicating whether any of the moving components of the vehicle is in abnormal condition. For example, the AI model may further output an anomaly score (or severity level) ranging from 1 to 4. A score of 1 indicates a critical issue requiring immediate attention, while a score of 4 signifies optimal vehicle performance. The anomaly score serves as an important indicator of the vehicle's condition, providing the operator with actionable insights into potential malfunctions that may require attention.

The above-described anomaly detection process takes a short period of time, and on completion the diagnostic output or report is sent back to the vehicle user (e.g., driver or mechanic).

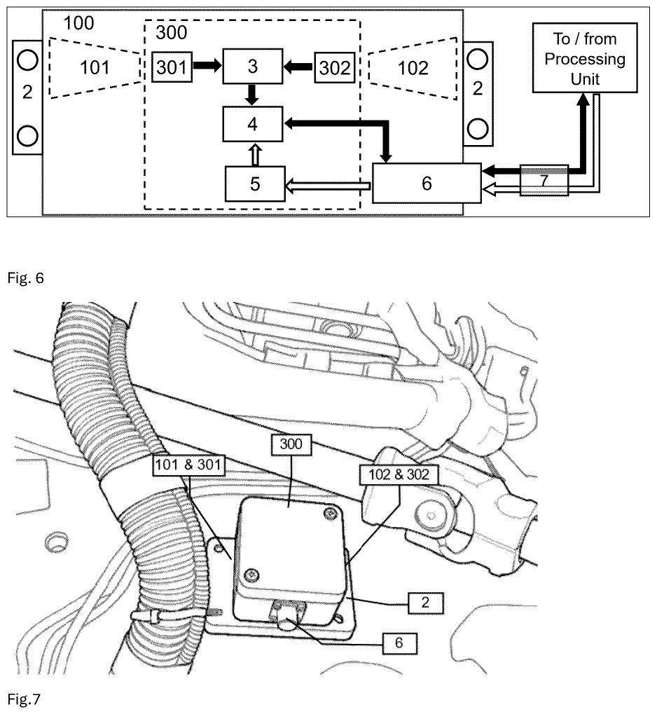

FIG. 6 shows a block diagram of a rigidly mounted acoustic data acquisition block that may be used in the system in accordance with one exemplary embodiment. It should be noted that there are two types of such a permanently installed system (i.e., when the acoustic data acquisition block(s) are rigidly mounted on the vehicle). The first type is designed as additional equipment for vehicles, enhancing their capabilities by providing real-time monitoring of mechanical systems; this type is installed on a vehicle as add-on, for example, by a service center. In contrast, the second type is designed-in and a factory-installed fully integrated predictive acoustic detection system tailored for electric, semi-autonomous, and luxury vehicles. During manufacturing, the second type is built directly into the vehicle, allowing it to optimally capture acoustic signals from critical components of the vehicle.

In FIG. 6, the acoustic data acquisition block is assumed to be housed within a waterproof enclosure 100, which might include mounting brackets 2 for reliable installation on the vehicle. The system employs acoustic ducts (also referred to as sound guides) 101 and 102, which are oriented in opposite directions to capture a broad range of acoustic signals and redirect them towards the acoustic sensors 301 and 302. Each of these sensors could be a digital MEMS or an analog microphone mounted on a carrier printed circuit board 300. Moreover, it could be two or more microphones to increase reliability and covered range of frequencies and intensities in real test conditions. These sound guides allow microphones to capture sounds from opposite directions; however, microphones themselves can be oriented in opposite directions. These sensors collect acoustic signals produced by the vehicle's moving components, such as wheel hubs, axles, bearings, steering, and suspension components. The carrier board 300 might include an ADC 3, a computational unit 4, a power management unit 5, and an interface electronics for exchanging digital data with a processing unit via a socket 6 and wired interface 7. The ADC 3 and the computational unit 4 may constitute the control unit of the acoustic data acquisition block shown in FIG. 6.

In FIG. 6, the solid arrows designate data communication lines, while the empty arrows designate power lines.

FIG. 7 shows an exemplary arrangement of the rigidly mounted acoustic data acquisition block in the vehicle on the front part of frame underneath of the vehicle.

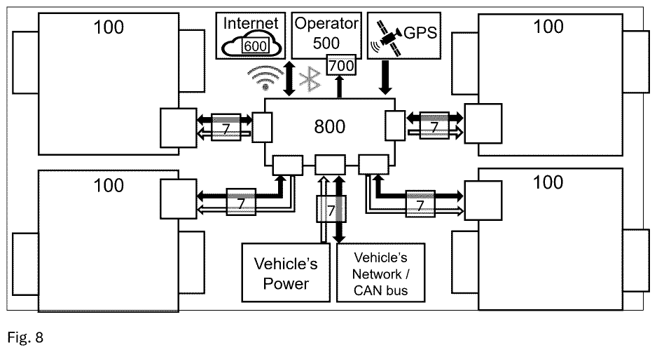

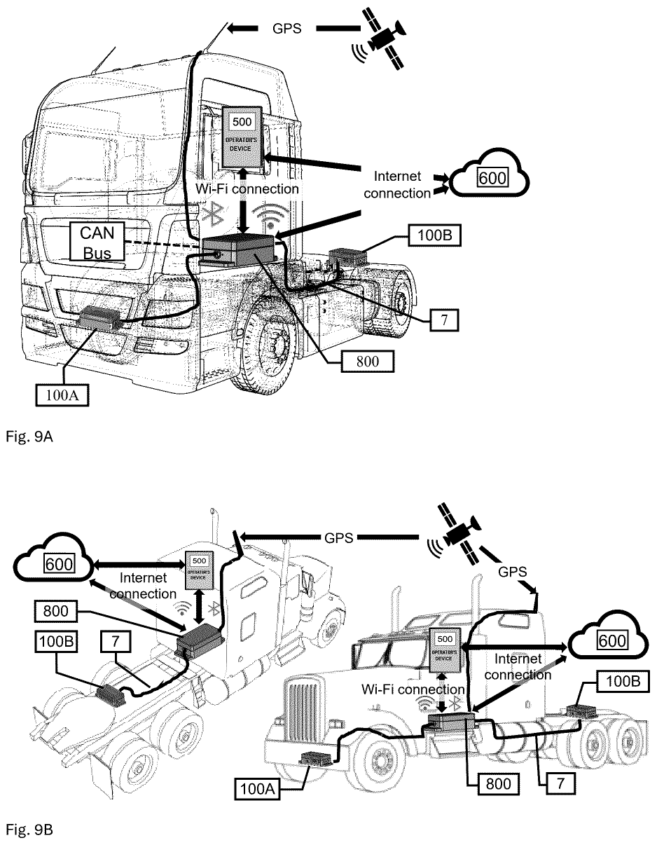

FIG. 8 shows a block diagram of the system with four rigidly mounted acoustic data acquisition blocks 100, a processing unit 800, and connection cables (or cable harness) 7 in accordance with one exemplary embodiment. The cable harness 7 connects the blocks 100 to the processing unit 800. The processing unit 800 is powered by a vehicle and provides power to the blocks 100. The processing unit 800 might have connection to a vehicle's network, e.g., CAN. Also, the processing unit 800 is shown to have a GPS antenna to receive Geo coordinates, Wi-Fi and Bluetooth interface allowing information exchange via the Internet with a cloud-based server 600 and an intermediate user (operator's) device 500. Again, the solid arrows designate data communication lines, while the empty arrows designate power lines.

FIGS. 9A and 9B show one exemplary configuration of the system with two rigidly mounted acoustic data acquisition blocks 100A (front) and 100B (rear) and a processing unit 800 on a truck. A cable harness 7 connects the blocks 100A and 100B to the processing unit 800. The processing unit 800 is powered by a vehicle and provides power to the blocks 100A and 100B. Collected acoustic data (in digital form) is transferred by the blocks 100A and 100B into the processing unit 800 in real time, and the processing unit 800 performs pre-filtering of the digital data and AI-based recognition of abnormalities. The processing unit 800 has a multitude of interfaces and might have connection to a vehicle network, for example, to CAN bus, to an intermediate user (operator's) device 500, to a cloud-based server 600 via the Internet, and could receive geo coordinates via GPS and environment information, such as weather-related, which increases recognition accuracy.

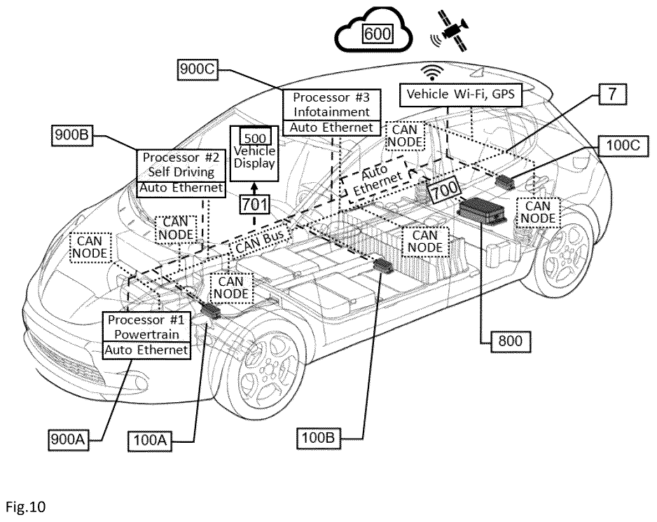

FIG. 10 shows one exemplary configuration of the system with three rigidly mounted acoustic data acquisition blocks 100A, 100B, and 100C and a processing unit 800 on a passenger car. The blocks 100A, 100B and 100C are shown to be mounted on the front, middle and rear parts of the vehicle, respectively. A cable harness 7 connects the blocks 100A, 100B and 100C to the processing unit 800. The vehicle network (CAN or Auto Ethernet as examples) has connections to the blocks 100A, 100B and 100C and to the processing unit 800; the network provides power. The blocks 100A, 100B and 100C send sound data (in digital form) via the vehicle network to the processing unit 800 which performs AI-based real time acoustic diagnostics. If any other vehicle processors and computers 900A, 900B, and 900C have computational capacity, they could also perform sound recognition and diagnostic functions of the processing unit 800. Using vehicle's wireless interfaces, the system could have connections to a cloud-based server 600 via the Internet and receive geo coordinates via vehicle's GPS. When the vehicle gets into a zone with reliable wireless connection, the system could exchange diagnostic results 700 and self-learned AI parameters with the cloud-based server 600 and get AI model updates therefrom. The system shown in FIG. 10 continuously analyzes vehicle sounds and stores diagnostic results 700. The vehicle operator or mechanic could access these results via a user intermediate device 500, for example, implemented as a user interface on a dashboard. If abnormality is detected, the system could display a warning on a dashboard for the rider, similar to “low tire pressure”, and also send a notification to a service center.

Let us now describe the operational principle of the system with one or more rigidly mounted acoustic data acquisition blocks.

### AI-Based Anomaly Detection and Failure Prediction Using DNNs

The advanced add-on on-board diagnostics system (first type) operates autonomously while the vehicle is in motion, utilizing the acoustic data acquisition blocks 100A, 100B, and 100C that capture acoustic signals from various moving components, such as the suspension and engine parts. The installation process involves securely mounting these blocks on strategic locations (as shown in FIG. 10) of the vehicle using quick-release brackets. Once installed, this add-on system automatically detects whether the vehicle is idle or in motion and begins recording the acoustic signals. The system preprocesses this recorded audio to filter out background noise, ensuring the accuracy of the data captured. The processing unit 800 performs advanced AI-based sound analysis which, in addition to the anomaly detection component, incorporates a separate model trained to recognize sounds indicative of specific malfunctions and defects. The system might store on board a “normal operation sound” as a reference to compare with it during operation. This portion of the AI model is designed to evaluate acoustic data with the aim of matching abnormal sound patterns to known sound signatures or patterns associated with common vehicle defects. Examples of such defects include, but are not limited to, wheel hub ball bearings, ball joints, suspension components, mud flaps, and engine auxiliary components such as belts, pulleys, tensioners, alternators, and air conditioning compressors.

The AI model is trained using a large dataset of known defect sound signatures, enabling it to identify specific sources of malfunction within the vehicle by analyzing the captured audio. Once an abnormal sound is detected, the AI model compares the sound against the stored signatures to classify the type of malfunction, providing valuable diagnostic information to the user.

While it can operate offline, the system also utilizes the intermediate user device 500, such as a smartphone, laptop, or tablet, to transmit the audio data (in digital form) along with different metadata (e.g., vehicle location, velocity, weather conditions, etc.) when connected to the Internet.

In addition to the on-board analysis (performed by the processing unit 800), the digital data could be sent to a cloud-based processing unit, which employs sophisticated AI algorithms, specifically DNNs, to analyze the digital data for anomalies and classify any detected malfunctions, generating a comprehensive diagnostic report 700. This report 700 details identified issues and may include for each issue an anomaly score ranging from 1 to 4, indicating the severity of detected problems, thereby enabling operators to make informed maintenance decisions. For predictive analytics, the cloud-based processing unit leverages historical diagnostic data specific to each vehicle, allowing it to track trends and patterns over time. Training of the AI model is conducted periodically, when critical metrics are reached, or manually, ensuring that the system remains effective. When the vehicle reaches a location with internet connectivity, it connects to the server 600 transferring its current parameters. The cloud-based server 600 sorts received info according to the vehicle make, model, year and other criteria creating identifiers and data groups for each unique vehicle type. After sorting, the server 600 analyzes recognized defects and self-learned AI parameters per a vehicle identifier. The server 600 recognizes the patterns and success rate of AI recognition and could modify recognition algorithms and parameters to improve performance. The cloud-based server 600 initiates its training process using historical data and current diagnostics to refine the AI model for that specific vehicle identifier. The updated model weights are then transferred back to the processing unit 800 via the communication channel, ensuring that the system continuously improves its diagnostic performance. Additionally, the PC-based or browser-based application provides a user-friendly interface for visualizing key metrics, including anomaly scores, historical trends, and diagnostic results, allowing operators to monitor vehicle health effectively.

The fully integrated system type (second type) mainly differs from the first type by utilizing the vehicle digital network to transfer audio data (in digital form) and diagnostic results 700. Upon activation when the vehicle is in motion, the system starts recording acoustic data using its embedded microphones. Similar to the add-on (first) type, the recorded audio is processed to eliminate background noise and sent to the processing unit 800 which performs advanced AI-based on-board sound analysis. The system could also send data to the cloud-based server 600 and receive updates from it. The DNN model within the processing unit 800 analyzes the sound for anomalies and classifies any detected malfunctions, generating the diagnostic report 700 that is integrated back into the vehicle's onboard system. Because the second-type system interacts directly with the vehicle's blocks—such as the engine control unit and other diagnostic modules—it can access real-time data from various sensors, improving the quality of predictions and optimizing its functionality specifically for that vehicle model. When traveling to a location with stable internet connectivity, the system connects to the server 600, transferring its current parameters and initiating a training process on the server 600 where the model updates are obtained using historical and real-time diagnostic data unique to that vehicle type. This training can occur periodically, when critical metrics are reached, or manually, ensuring the model is always aligned with the vehicle's current condition. Subsequently, the updated model weights are communicated back to the processing unit 800, ensuring that the on-board system continuously enhances its accuracy and effectiveness in detecting and classifying mechanical issues. The customized diagnostic application also plays a crucial role in visualizing metrics for that system, providing operators with insights into vehicle performance, anomaly scores, and historical data trends, thus facilitating proactive maintenance and ensuring optimal vehicle safety and performance.

Both permanently installed, add-on (first type) and fully integrated (second type) systems provide comprehensive, advanced diagnostics with add-on system offering flexibility for various vehicles and integrated type delivering insights tailored to specific car models.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A system for acoustic diagnostics of a vehicle, the system comprising:
at least one acoustic data acquisition block mounted on the vehicle, each of the at least one acoustic data acquisition block being configured to capture acoustic signals from moving components of the vehicle;
a communication interface; and
a processing unit mounted on the vehicle, the processing unit being coupled to each of the at least one acoustic data acquisition block via the communication interface, the processing unit being configured to analyze the acoustic signals to detect an abnormal condition of each of the moving components of the vehicle;
wherein each of the at least one data acquisition block comprises:
at least two microphones capturing sound from opposite directions and configured to capture the acoustic signals from the moving components of the vehicle;
a memory; and
a control unit configured to:
convert the acoustic signals into digital data;
store the digital data in the memory; and
transmit the digital data to the processing unit via the communication interface;
wherein the processing unit is configured to analyze the digital data by using an artificial intelligence (AI) model, the AI model being configured to:
receive the digital data as input data;
compare the digital data to a normal sound pattern of each of the moving components of the vehicle; and
based on said comparison, generate a diagnostic output indicating whether at least one of the moving components of the vehicle is in the abnormal condition.

2. The system of claim 1, wherein at least one acoustic data acquisition block comprises:
a first acoustic data acquisition block mounted on a front part of the vehicle;
a second acoustic data acquisition block mounted on a rear part of the vehicle; and
optionally a third acoustic data acquisition block mounted on a middle part of the vehicle.

3. The system of claim 1, wherein each of the at least one acoustic data acquisition block further comprises at least two acoustic ducts each arranged to concentrate and redirect the acoustic signals from the moving components of the vehicle towards two or more microphones.

4. The system of claim 1, wherein each of the at least one acoustic data acquisition block further comprises an autonomous power source configured to power the control unit.

5. The system of claim 4, wherein the autonomous power source is configured to recharge from a power source of the vehicle.

6. The system of claim 1, wherein the communication interface comprises one of a wireless interface, a wired interface and an optical interface.

7. The system of claim 1, further comprising an intermediate user device, and wherein each of the at least one acoustic data acquisition block is wirelessly coupled to the intermediate user device, the control unit of each of the at least one acoustic data acquisition block is further configured to transmit the digital data to the intermediate user device, and the intermediate user device is configured to forward the digital data to the processing unit if the processing unit fails to receive the digital data via the communication interface.

8. The system of claim 7, wherein the intermediate user device comprises a positioning module configured to provide metadata to each of the at least one acoustic data acquisition block, the metadata comprising positioning information about the vehicle and environmental data, and wherein the control unit of each of the at least one acoustic data acquisition block is further configured to store the metadata in the memory and transmit the metadata together with the digital data to the processing unit.

9. The system of claim 8, wherein the processing unit is further configured to transmit the diagnostic output to the intermediate user device.

10. The system of claim 1, wherein the AI model comprises a deep neural network (DNN) having an autoencoder architecture that integrates convolutional neural networks (CNNs) and attention mechanisms.

11. The system of claim 1, wherein the processing unit is further configured, if the diagnostic output indicates the abnormal condition of at least one of the moving components of the vehicle, to provide at least one of a visual warning and an audio warning to a user of the vehicle.

12. The system of claim 1, wherein the diagnostic output further indicates, in case of the abnormal condition of at least one of the moving components of the vehicle, at least one of:
a severity level associated with the abnormal condition of said at least one of the moving components of the vehicle;
a malfunction class associated with the abnormal condition of said at least one of the moving components of the vehicle;
and a maintenance scheduling recommendation.

13. The system of claim 1, further comprising a remote AI server storing the AI model, and wherein the processing unit is further configured to transmit the digital data and the diagnostic output to the remote AI server, and the remote AI server is configured to obtain updates to the AI model by training the AI model based on the digital data and the diagnostic output and to transmit the updates to the processing unit.

14. The system of claim 1, wherein the AI model is further configured to predict future abnormal conditions of the moving components of vehicle and maintenance needs with respect to the moving components of the vehicle based on historical vehicle diagnostics data, and wherein the historical diagnostics data comprises at least one of:
previous diagnostic outputs generated by the AI model;
malfunction classes corresponding to abnormal conditions indicated in the previous diagnostic outputs;
an average speed of travel;
a time of year;
time- and frequency-domain features of the acoustic signals;
a mileage of the vehicle;
driving conditions; and
a maintenance history of the vehicle.

15. The system of claim 14, wherein the AI model is configured to predict the future abnormal conditions and the maintenance needs by using a time series model to analyze trends and patterns in the acoustic signals over time.

16. The system of claim 15, wherein the time series model comprises at least one of:
an auto regressive integrated moving average (ARIMA) model;
a long short-term memory (LSTM) model; and
a transformer-based time series model.
